(19) United States
(12) Patent Application Publication
(10) Pub. No.: US 2014/0004032 A1
(43) Pub. Date: Jan. 2, 2014

(54) METHOD AND APPARATUS FOR RAPID GROWTH OF DIAMOND FILM

(71) Applicant: KOREA INSTITUTE OF SCIENCE AND TECHNOLOGY, Seoul (KR)

(72) Inventors: Young Joon BAIK, Seoul (KR); Jong Keuk PARK, Seoul (KR); Wook Seong LEE, Seoul (KR)

(21) Appl. No.: 13/929,941

(22) Filed: Jun. 28, 2013

(30) Foreign Application Priority Data
Jul. 2, 2012 (KR) 10-2012-0071532

(51) Int. Cl. C01B 31/06

(52) U.S. Cl. CPC C01B 31/06
USPC 423/446; 422/198

(57) ABSTRACT

Provided are a method and an apparatus for rapid growth of a diamond capable of synthesizing a diamond having a large area and increasing a rate of synthesis of the diamond. The method for rapid growth of a diamond according to the present disclosure using a hot filament chemical vapor deposition (HFCVD) method includes: controlling a concentration of atomic hydrogen by controlling a flow rate of a precursor gas including hydrogen and hydrocarbon; and providing a solid phase carbon source which is etched by atomic hydrogen to increase a degree of supersaturation of a carbon source in a chamber of an HFCVD apparatus.

### CROSS-REFERENCE TO RELATED APPLICATION

This application claims priority to Korean Patent Application No. 10-2012-0071532, filed on Jul. 2, 2012, and all the benefits accruing therefrom under 35 U.S.C. §119, the contents of which in its entirety are herein incorporated by reference.

### BACKGROUND

1. Field

The following disclosure relates to a method and an apparatus for rapid growth of a diamond, and more particularly, to a method and an apparatus for rapid growth of a diamond capable of synthesizing a diamond having a large area and increasing a rate of synthesis of the diamond.

2. Description of the Related Art

Diamond has various and excellent physical properties. Among existing materials, diamond has the highest hardness, thermal conductivity, and light transmittance, and can be applied in various fields. The artificial synthesis of diamonds is classified into a high-pressure high-temperature (HPHT) synthesis method and a chemical vapor deposition (CVD) method (refer to K. Kobashi, Diamond Films: Chemical Vapor Deposition for Oriented and Heteroepitaxial Growth, Elsevier, 2005). A diamond synthesized by the former has a powder form, and a diamond synthesized by the latter has a form of a film coated on a substrate. Therefore, the latter may be an appropriate method for various industrial applications.

Diamonds may be manufactured in various forms according to application fields. Diamonds may be manufactured in various manners for a case of a product that includes a parent material to be coated by a diamond such as a coating of a cutting tool, a case where a diamond is synthesized as a thick film plate material and is processed into desired form and size for use, a case where a diamond is synthesized in a form of an independent particle for use, and the like. As a vapor phase synthesis method of diamonds for this, there are a hot filament chemical vapor deposition (HFCVD) method (Korean Patent No. 10-0382943) in which heat is used according to an activation method of a reacting gas, and a plasma assisted chemical vapor deposition (PACVD) method in which plasma is used. Depending on the properties of the plasma used, there are a low temperature plasma method and a high temperature plasma method.

The HFCVD method and the low temperature PACVD method have an advantage of enlarging a synthesis area of a diamond, but have a disadvantage of a low rate of synthesis. The high temperature PACVD method has a high rate of synthesis, but has a disadvantage of a small synthesis area.

### RELATED LITERATURES

### Patent Literature

Korean Patent No. 10-0382943

### Non Patent Literature

K. Kobashi, “Diamond Films: Chemical Vapor Deposition for Oriented and Heteroepitaxial Growth”, Elsevier, 2005, pp. 17-27.

S. Matsumoto, et al., “Vapor Deposition of Diamond Particles from Methane”, Jpn. J. Appl. Phys., Vol. 21, No. 4, April, 1982, pp. L183-L185.

John F. O'Hanlon, “A user's guide to vacuum technology”, John Wiley & Sons, 1989, pp. 10-13.

Jeoung Woo Kim, “The nucleation behavior of diamond during gas phase synthesis”, a doctoral dissertation, KAIST, 1991, pp. 33-35.

### SUMMARY

An embodiment of the present disclosure is directed to providing a method and an apparatus for rapid growth of a diamond capable of synthesizing a diamond having a large area and increasing a rate of synthesis of the diamond.

In one aspect, there is provided a method for rapid growth of a diamond using a hot filament chemical vapor deposition (HFCVD) method, including: controlling a concentration of atomic hydrogen at a deposition site of a substrate by controlling a flow rate of a precursor gas including hydrogen and hydrocarbon; and providing a solid phase carbon source which is etched by atomic hydrogen to increase a degree of supersaturation of a carbon source in a chamber of an HFCVD apparatus.

The precursor gas may be supplied at a flow rate of 2 to 500 sccm per unit area of 1 cm² of the substrate on which the diamond is grown. When the flow rate of the precursor gas is increased, the concentration of atomic hydrogen and a rate of deposition of a diamond thin film may be increased.

The solid phase carbon source may be a graphite substrate, diamond particles may be provided on the graphite substrate, and a diamond may be grown on the diamond particles. In addition, the solid phase carbon source may be a graphite structure, the graphite structure may be disposed between a high melting point filament of the HFCVD apparatus and a diamond deposition substrate, and the graphite structure may be provided with an opening portion which is a space for movement of gas.

In another aspect, there is provided an apparatus for rapid growth of a diamond, including: a chamber providing a space for reaction of diamond synthesis; a cooling block being provided in the chamber to provide a space for mounting a substrate, and controlling a temperature of the substrate; a high melting point filament being provided at a position separated from an upper portion of the substrate; a precursor gas supply unit supplying a precursor gas including hydrogen and hydrocarbon into the chamber; and a solid phase carbon source being etched by atomic hydrogen generated from the precursor gas to increase a degree of supersaturation of a carbon source.

The method and the apparatus for rapid growth of a diamond according to the present disclosure have the following effects.

As the concentration of atomic hydrogen is increased, the generation of the graphite phase may be suppressed, and by increasing the degree of supersaturation of the carbon source at the deposition site of the substrate using the solid carbon source, increases in the rate of deposition of the diamond and in the area of the diamond thin film may be implemented.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 is a configuration diagram of a general HFCVD apparatus;

FIG. 2 is a configuration diagram of an HFCVD apparatus according to an embodiment of the present disclosure;

FIG. 3 is a configuration diagram of the HFCVD apparatus according to another embodiment of the present disclosure; and

FIGS. 4A and 4B are plan views of a graphite structure of FIG. 3 according to some embodiments.

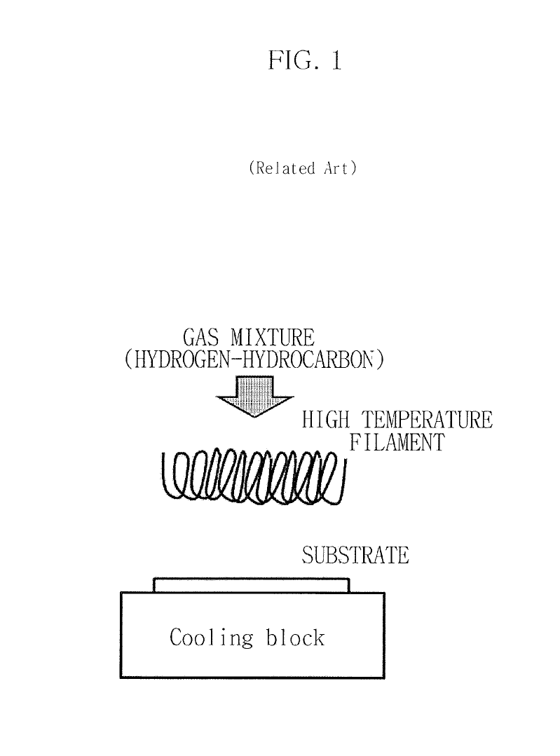

### DETAILED DESCRIPTION

Exemplary embodiments now will be described more fully hereinafter with reference to the accompanying drawings, in which exemplary embodiments are shown.

An embodiment of the present disclosure is directed to rapid deposition of a diamond having a large area, and for this, a method of increasing 1) a degree of supersaturation of a carbon source and 2) a concentration of atomic hydrogen at a deposition site on a substrate is applied. In following embodiments, graphite plates and particular structures which can be used as the carbon source include graphite as well as a solid comprised of carbon.

In a typical vapor deposition method for a diamond, a gas mixture of hydrogen and hydrocarbon is used as a precursor of diamond synthesis. In order to increase the rate of synthesis and the area of a diamond, the amount of hydrocarbon included in the gas mixture should be increased. However, when the amount of hydrocarbon is increased, the proportion of a graphite phase in the deposited diamond film during the diamond synthesis is increased, and thus the amount of hydrocarbon included in the gas mixture during actual diamond synthesis is limited.

In the present disclosure, as a way to suppress generation of the graphite phase, increasing the concentration of atomic hydrogen at a deposition site on a substrate is employed. Atomic hydrogen refers to hydrogen in an atomic state, and has a function of etching the graphite phase during diamond synthesis. In addition, as the concentration of atomic hydrogen is increased, the generation of the graphite phase may be suppressed.

Atomic hydrogen is formed by thermal decomposition of hydrogen and hydrocarbon as the precursor gas. Atomic hydrogen is moved toward a diamond synthesis substrate mainly by diffusion, and most atomic hydrogen disappears through recombination due to collisions with other particles during moving. When a diamond deposition process using a HFCVD process is exemplified, the temperature of a filament is approximately 2000° C., and the temperature of a substrate is approximately 1000° C. Thermodynamically, the concentration of atomic hydrogen at the former temperature (2000° C.) is calculated to be 10⁵ times higher than that at the latter temperature (1000° C.). Accordingly, it can be seen that the concentration of atomic hydrogen at a deposition site on a substrate is significantly reduced.

In an embodiment of the present disclosure, in order to reduce the recombination of atomic hydrogen and maintain the concentration of atomic hydrogen that reaches the substrate at a certain level or higher, a method of increasing the flow rate of the precursor gas (that is, the flow rate of the gas mixture of hydrogen and hydrocarbon) is applied. In a case of using the same apparatus, an increase in the flow rate of gas means an increase in the flow velocity of the gas. When the flow velocity of the precursor gas is increased, the movement speed of atomic hydrogen generated from the precursor gas is also increased. In addition, when the movement speed of atomic hydrogen is increased, the frequency of collisions between atomic hydrogen and other gases is reduced. Accordingly, the concentration of atomic hydrogen that reaches the substrate may be increased to be a certain level or higher.

In the above description, it is described that there is a limitation on an increase in the amount of hydrocarbon due to the increase in the graphite phase. In the embodiment of the present disclosure, the possibility of an increase in the graphite phase may be inhibited by increasing the concentration of atomic hydrogen. From this, it can be predicted that rapid synthesis thereof may be achieved by supplying a larger amount of hydrocarbon during diamond synthesis.

In the present disclosure, as the method of increasing the amount of hydrocarbon, that is, as the method of increasing the degree of supersaturation of a carbon source, instead of a method of increasing the amount of hydrocarbon in the precursor gas, a method of using a graphite substrate or a graphite structure during diamond synthesis is employed. The graphite substrate or the graphite structure is etched by atomic hydrogen, the etched graphite reacts with hydrogen and forms a hydrocarbon state, and accordingly the degree of supersaturation of the carbon source is increased. The degree of supersaturation of the carbon source is directly connected to a rate of deposition of a diamond. As the degree of supersaturation of the carbon source is increased, the rate of deposition of a diamond is increased.

From the above description, it can be seen that increases in the rate of synthesis of a diamond may be sufficiently achieved by increasing the concentration of atomic hydrogen and the concentration of the carbon source at the deposition site on the substrate.

Meanwhile, the method for rapid growth of a diamond according to the present disclosure is performed by an HFCVD apparatus. A typical HFCVD apparatus includes a chamber, a cooling block, and a high melting point filament. The chamber provides a space for reaction, the cooling block is provided in the chamber, provides a space for mounting the substrate, and controls the temperature of a substrate, and the high melting point filament is heated by power applied.

In the HFCVD apparatus described above, the filament is separated from the substrate by about 1 cm, and is heated to 2000° C. or higher to activate the precursor gas (that is, the gas mixture of hydrogen and hydrocarbon). The activated gas is moved toward the substrate, and recombination of the gases occurs due to the interaction caused by collisions between the atoms during moving. Accordingly, the degree of activation of the gases is significantly reduced, and the concentration of atomic hydrogen is also reduced. Therefore, when the distance between the substrate and the filament is a certain value or higher, diamond synthesis does not occur. In addition, it is reported that as the distance is reduced, the rate of deposition of a diamond and the content of a graphite phase are reduced (Jeoung Woo Kim, “The nucleation behavior of diamond during gas phase synthesis”, a doctoral dissertation, KAIST, 1991, pp. 33-35)

In the HFCVD method, a pressure used for diamond synthesis is generally about 10 to 60 Torr. In this pressure range, the mean free path is about several micrometers (John F. O'Hanlon, “A user's guide to vacuum technology”, John Wiley & Sons, 1989, pp. 10-13). Therefore, while the activated gases are moved from the filament to the substrate, sufficient contacts and collisions between the gas atoms occur. When thermodynamic equilibrium of the gases at the substrate temperature is achieved by these collisions, only graphite has to be deposited. However, by a result of an experiment, a diamond is deposited, thus it can be seen that atomic hydrogen is still present while being supersaturated.

It is inferred that this result comes from two possibilities. One is a possibility that although collisions between the gas atoms occur at a synthesis pressure of tens of torr, since gas species activated at the filament are continuously supplied and a reaction time to achieve thermodynamic equilibrium between the gas atoms is insufficient, the activation of the gases may be maintained at a certain degree. The other is a case where the temperature gradient from the filament to the substrate is not formed with a linearly gentle gradient, and but is formed as a steep gradient near at the surface site of the substrate. In this case, it is difficult to form thermodynamic equilibrium between the gas species corresponding to the steep temperature gradient at the surface site of the substrate, and thus there is a possibility that the degree of activation of the gases may be maintained. The present disclosure is made based on the possibilities, which enables rapid growth of a diamond.

Generally, the mixing flow rate of the gas (the gas mixture of hydrogen and hydrocarbon) used for diamond synthesis is about 100 sccm (standard cubic centimeter per minute). Since the size of the chamber of the HFCVD apparatus is about 0.2 to 1 m³, the movement of the gas species from the filament to the substrate proceeds by diffusion. In the HFCVD apparatus, when the movement speed of the gas atoms is intentionally increased, the frequency of collisions between the gas atoms may be reduced while the gas atoms move from the filament to the substrate. The reduction in the frequency of collisions causes a reduction in the rate of reaction between the gas atoms. Subsequently, the degree of activation of the gas generated at the filament may be maintained at a higher level, and thus the concentration of atomic hydrogen at the substrate site may be maintained at a high level. As an example, if the movement speed of the gas may be increased by several times by increasing the flow rate of the gas, the reduction rate of the degree of activation of the gas at the substrate site may be as much reduced. The effect of the reduction in collisions between the gas species by controlling the movement speed of the gas is similar to the effect of the reduction in the distance between the filament and the substrate. In addition, when the formation of the graphite phase in the deposited thin film may be reduced, the rate of deposition of the film may be increased.

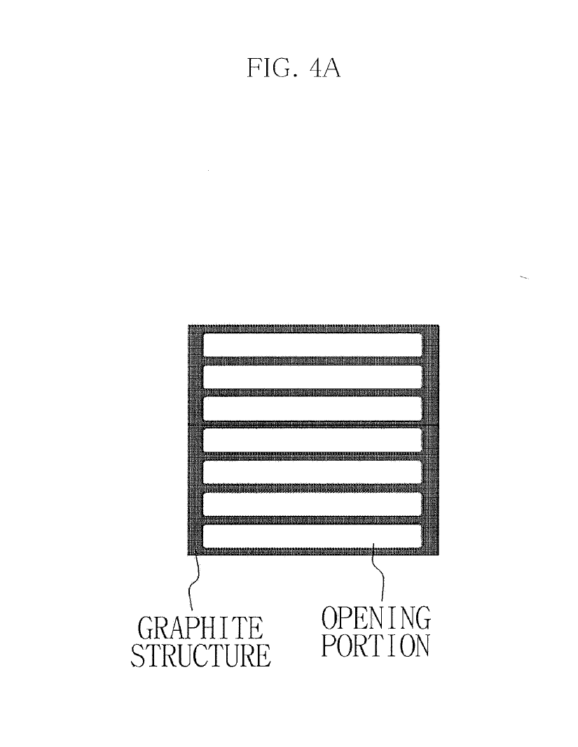

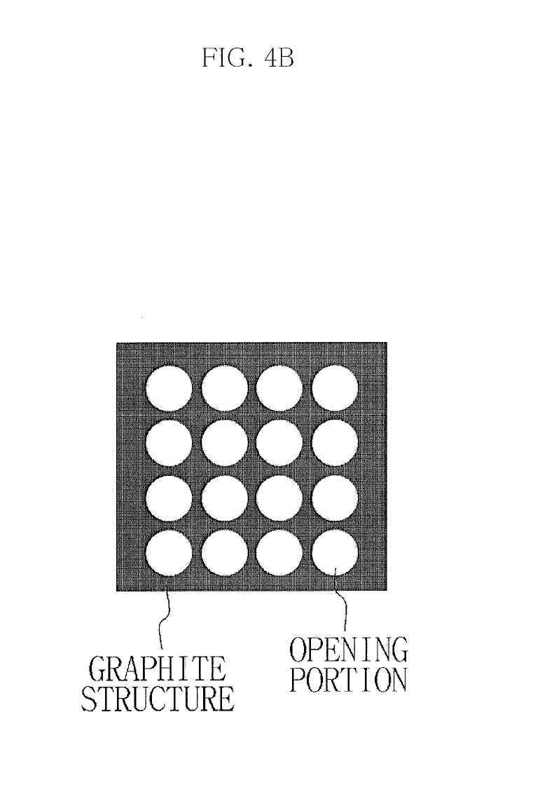

Meanwhile, as the method for increasing the degree of the supersaturation of the carbon source in the present disclosure, a graphite substrate is used as a growth substrate for a diamond, or a graphite structure is disposed at a position separated from the upper portion of the growth substrate for a diamond. The graphite substrate and the graphite structure are etched by atomic hydrogen and are vaporized in the form of hydrocarbon. Accordingly, the degree of supersaturation of the carbon source is increased. In the case of the graphite structure, in order to uniformly deposit a diamond on the entire surface of the substrate, opening portions (see FIGS. 4A and 4B) are provided.

Hereinafter, the method and the apparatus for rapid growth of a diamond according to the present disclosure will be described in detail with reference to Examples.

### EXAMPLE 1

### Rapid Growth of Diamond Using Graphite Substrate

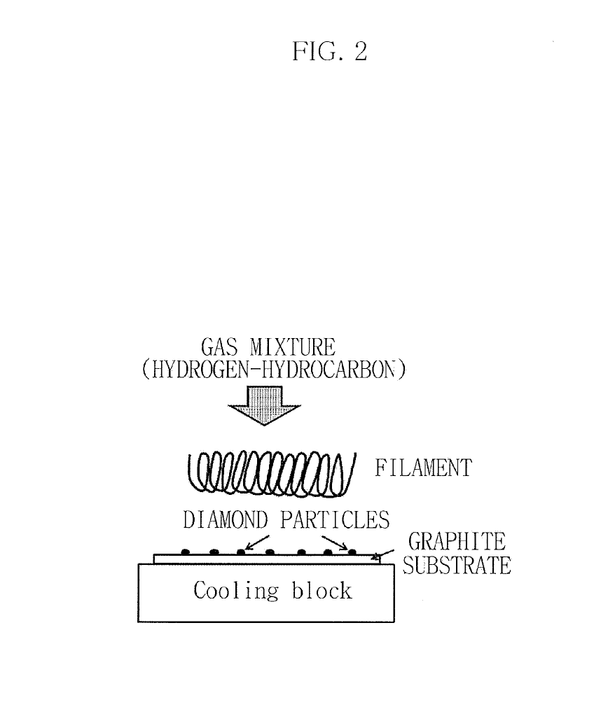

A diamond thin film was grown on a circular graphite substrate. Specifically, a graphite substrate having a diameter of 5 cm and a thickness of 3 mm was prepared, diamond particles having sizes of about 100 μm were dispersed on the graphite substrate in a grid pattern at intervals of 5 mm. Next, the graphite substrate on which the diamond particles are dispersed was inserted into an HFCVD apparatus for diamond deposition for 10 hours. The distance between the substrate and the graphite substrate was maintained at 1 cm, and the synthesis pressure was 40 Torr, 0.5% of methane and 99.5% of hydrogen were used as a precursor gas, and the temperatures of a filament and the substrate were fixed to 2100° C. and 950° C., respectively. In addition, diamond deposition had progressed while changing the flow rate of the precursor gas to 100 sccm, 1 slm (standard liter per minute), 2 slm, 3 slm, 4 slm, and 5 slm. The HFCVD apparatus of Example 1 is as illustrated in the schematic diagram of FIG. 2. Here, since the graphite substrate was not subjected to an additional surface treatment, diamond deposition had not occurred, and diamond deposition had progressed only on the diamond particles dispersed on the graphite substrate.

In a case where the flow rate of the precursor gas was 100 sccm, the growth rate of a side surface of the diamond particles was 0.6 μm/h. Since the growth of the diamond had progressed in both side directions when viewed from the above, the growth rate in the height direction was 0.3 μm/h which was the half the growth rate in both side directions. As the flow rate of the precursor gas was increased, the growth rate of the particles was rapidly increased. A growth rate of about 9.5 μm/h was shown at a flow rate of 5 slm, and it was observed that the growth rate was increased in proportion to the flow rate. The grown diamond particle had a hemispheric shape. From this result, a gradual increase in the rate of deposition could be verified in a case where the gas was supplied at a flow rate of 2 to 500 sccm per unit area of 1 cm²of the substrate. In a case where the flow rate is 2 sccm or less, the concentration of atomic hydrogen is low and may not affect the rate of deposition of the diamond. In a case where the flow rate is 500 sccm or higher, the concentration of atomic hydrogen is not further increased.

The method in Example 1 is an effective method for the deposition of a diamond, but is not appropriate for a case where a diamond is deposited in a continuous film form. The reason is that since the carbon source is generated by etching of the graphite and is supplied by gas diffusion, a concentration gradient of carbon or hydrocarbon is generated as the distance from the graphite substrate is increased, and accordingly the possibility that uneven deposition may occur is high. In this case, an efficient arrangement of the sold carbon source is necessary.

### EXAMPLE 2

### Rapid Growth of Diamond Using Graphite Structure

In the case of Example 1, the maximum deposition size was about 1 cm, and the diamond was grown in a separated form. Here, in a case where the deposition size was increased to several centimeters or greater, a phenomenon in which the rate of deposition was reduced toward the center of a deposit had occurred.

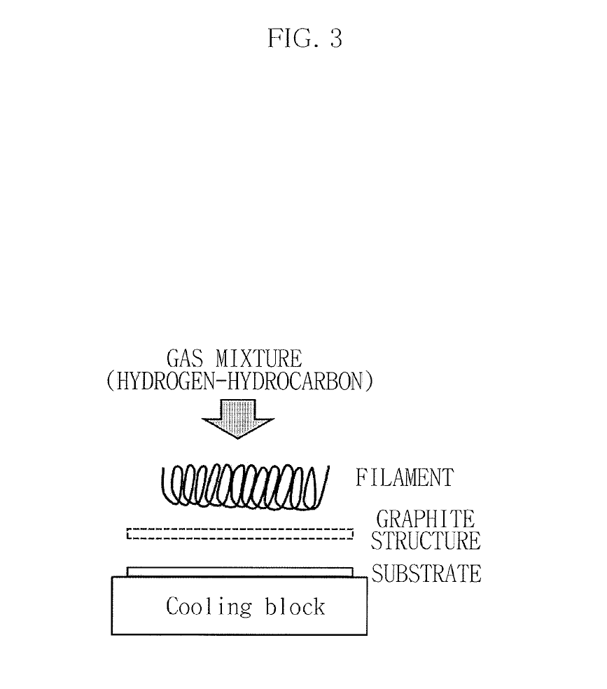

In order to solve this, in Example 2, diamond deposition had progressed in a state where a graphite structure was disposed between a diamond deposition substrate and a filament. The processing conditions were the same as those in Example 1. However, the graphite structure was provided at a position 4 mm away from the substrate, and the flow rate of the precursor gas was set to 1 slm and 5 slm. In addition, in order to compensate for a temperature decrease caused by the graphite structure, the temperature of the filament was set to 2350° C. An HFCVD apparatus of Example 2 is as illustrated in the schematic diagram of FIG. 3.

After 10-hours deposition, the cross section was observed in order to check the unevenness of deposition caused by the graphite structure. Although the thickness of a film at a portion where the opening portion of the graphite structure was provided was slightly large, a thickness deviation was observed as 5% or less. The average rate of deposition of the diamond thin film was measured as about 0.5 μm/h in a case of a flow rate of 1 slm, and as about 7 μm/h in a case of a flow rate of 5 slm.

It was shown that the rate of deposition of the diamond thin film was significantly increased higher than the growth rate in the height direction estimated in Example 1. It is determined that the reason is that the position of the graphite structure is closer to the filament than the graphite substrate of Example 1, the concentration of atomic hydrogen in the graphite structure is increased as the temperature of the filament is higher than that of Example 1, and accordingly the carbon concentration in the gas increased as the etching speed of the graphite structure is increased.

While the exemplary embodiments have been shown and described, it will be understood by those skilled in the art that various changes in form and details may be made thereto without departing from the spirit and scope of the present disclosure as defined by the appended claims.

What is claimed is:

1. A method for rapid growth of a diamond using a hot filament chemical vapor deposition (HFCVD) method, comprising:
controlling a concentration of atomic hydrogen by controlling a flow rate of a precursor gas including hydrogen and hydrocarbon; and
providing a solid phase carbon source in a chamber of an HFCVD apparatus, the solid phase carbon source being etched by atomic hydrogen to increase a degree of supersaturation of a carbon source,
wherein the solid phase carbon source is disposed between a high melting point filament of the HFCVD apparatus and a diamond deposition substrate, and has an opening portion which is a space for movement of gas.

2. The method for rapid growth of a diamond according to claim 1,
wherein the precursor gas is provided at a flow rate of 2 to 500 sccm per unit area of 1 cm² of the substrate on which the diamond is grown.

3. The method for rapid growth of a diamond according to claim 1,
wherein when the flow rate of the precursor gas is increased, the concentration of atomic hydrogen and a rate of deposition of a diamond thin film are increased.

4. The method for rapid growth of a diamond according to claim 1,
wherein diamond particles are provided on the solid phase carbon source, and a diamond is grown on the diamond particles.

5. The method for rapid growth of a diamond according to claim 1,
wherein the solid phase carbon source includes a graphite structure.

6. An apparatus for rapid growth of a diamond, comprising:
a chamber configured to provide a space for reaction of diamond synthesis;
a cooling block configured to provide a space for mounting a substrate, and control a temperature of the substrate in the chamber;
a high melting point filament configured to be disposed apart from an upper portion of the substrate;
a precursor gas supply unit configured to provide a precursor gas including hydrogen and hydrocarbon into the chamber; and
a solid phase carbon source configured to be etched by atomic hydrogen generated from the precursor gas to increase a degree of supersaturation of a carbon source,
wherein the solid phase carbon source is disposed between the high melting point filament and the substrate, and has an opening portion which is a space for movement of gas.

7. The apparatus for rapid growth of a diamond according to claim 5,
wherein the precursor gas supply unit provides the precursor gas at a flow rate of 2 to 500 sccm per unit area of 1 cm² of the substrate on which a diamond is grown.

8. The apparatus for rapid growth of a diamond according to claim 5,
wherein, when the flow rate of the precursor gas is increased, a concentration of atomic hydrogen and a rate of deposition of a diamond thin film are increased.

9. The apparatus for rapid growth of a diamond according to claim 5,
Wherein the solid phase carbon source includes a graphite structure.
